(19) United States
(12) Patent Application Publication
(10) Pub. No.: US 2008/0206560 A1
(43) Pub. Date: Aug. 28, 2008

(54) PHOSPAHTE COATED STAINLESS STEEL WIRE FOR COLD HEADING AND SELF-DRILLING SCREW USING THE STAINLESS STEEL WIRE

(76) Inventors: Ju Hwan PARK, Yangsan-city (KR); Ki Hong KIM, Yangsan-city (KR); Jeong Won HA, Yangsan-city (KR); Sang Jin KIM, Yangsan-city (KR); Jong Gik HAN, Busan-city (KR)

Correspondence Address: LADAS & PARRY LLP, 224 SOUTH MICHIGAN AVENUE, SUITE 1600, CHICAGO, IL, 60604, US

(21) Appl. No.: 11/946,145

(22) Filed: Nov. 28, 2007

(30) Foreign Application Priority Data
Feb. 27, 2007 (KR) 10-2007-0019908
Apr. 9, 2007 (KR) 10-2007-0034612

(51) Int. Cl. B32B 15/02; F16B 25/10

(52) U.S. Cl. 428/380; 428/379; 411/387.6

(57) ABSTRACT

Provided are a phosphate coated stainless steel wire for cold heading and a self-drilling screw using the stainless steel wire. Since a phosphate coating is formed on a surface of the stainless steel wire, cold headability and clamping force can be significantly improved, and since outer appearance is improved, a post-process after a heading is not required.

### CROSS-REFERENCE TO RELATED PATENT APPLICATION

This application claims the benefit of Korean Patent Application Nos. 10-2007-0019908, filed on Feb. 27, 2007 and Korean Patent Application No. 10-2007-0034612 filed on Apr. 9, 2007 in the Korean Intellectual Property Office, the disclosure of which is incorporated herein in its entirety by reference.

### BACKGROUND OF THE INVENTION

1. Field of the Invention

The present invention relates to a stainless steel wire for cold heading and a self-drilling screw using the stainless steel wire, and more particularly, to a phosphate coated stainless steel wire for cold heading and a self-drilling screw using the stainless steel wire.

2. Description of the Related Art

In general, stainless steel wires for cold heading refer to stainless steel wires used to produce components in specific shapes through a cold heading process, such as small screws, wood screws, tapping screws, or bolts.

Since stainless steel wires for cold heading are used to produce components in specific shapes, such as small screws, the stainless steel wires should have high cold headability. Since stainless steel wires for cold heading have to go through a severe heading process using a high-speed header, the stainless steel wires should have sufficient lubricity with respect to the high-speed header so as not to make crack during the severe heading process.

In particular, since stainless steel wires for cold heading used to produce self-drilling screws having sharp point at the end thereof to drill hole into a steel plate or the like have to go through a pointing process under severe conditions than those of a heading process, the stainless steel wires for cold heading used to produce the self-drilling screws should have high cold headability, crack resistance, and lubricity with respect to a tool.

While conventional screws are inserted into holes that are already formed by a driller, self-drilling screws having sharp point at the end thereof directly drill holes into an object to be coupled, such as a steel plate. Accordingly, because of ease of application and high clamping force, the self-drilling screws are widely used to build a steel structure, such as a plant, a steel house, or a gymnasium, where panels are attached to H-beams.

In this respect, inorganic salt coated, copper plated, or oxalate coated stainless steel wires have been used.

An inorganic salt coated stainless steel wire disclosed in Korean Patent Registration No. 210824 is physically coated with a water-soluble coating composition containing sulfate and surfactant. Inorganic salt coating is widely used as a substitute for current resin coating. The inorganic salt coating has high adhesion to a surface of a stainless steel wire and enables a dry lubricant to be easily carried into dies, thereby enhancing the life of the dies. Also, since the inorganic salt coating has high anti-seizure property, high speed wiredrawing can be carried out, and since the inorganic salt coating is water soluble, degreasing can be carried out with an alkali solution. However, since an inorganic salt coated stainless steel wire has a rough surface and lacks lubricity, the inorganic salt coated stainless steel wire is not suitable for a cold heading process requiring severe operation conditions.

Although a copper plated stainless steel wire has high lubricity with respect to a header, pollution is caused by a copper plating process and a copper plating material remained after a cold heading process should be removed.

An oxalate coated stainless steel wire can stand a heading process, and enables a lubricant to be easily carried into dies, thereby reducing the abrasion of the dies. However, lots of harmful fumes and heavy metals, such as Cr6+, are produced during an oxalate coating process.

A method for electrochemical phosphating of metal surfaces, particularly stainless steel wherein a phosphate coated stainless steel plate is deep drawn is disclosed in International Patent Publication No. WO 98/09006. However, a phosphate coated stainless steel wire and a method of cold heading the stainless steel wire are not disclosed in International Patent Publication No. WO 98/09006.

### SUMMARY OF THE INVENTION

The present invention provides a phosphate coated stainless steel wire for cold heading which has high cold headability.

The present invention also provides a phosphate coated stainless steel wire for cold heading which can stand a severe cold heading process such as a pointing process.

The present invention also provides a self-drilling screw produced using a phosphate coated stainless steel wire for cold heading, which has high clamping force, short insertion time, and good appearance, and does not cause pollution during a manufacturing process.

According to an aspect of the present invention, there is provided a stainless steel wire for cold heading, the stainless steel wire comprising a phosphate coating formed on a surface thereof. The phosphate coating formed on the surface of the stainless steel wire may have a weight of 4.0 to 14.0 g/m².

According to another aspect of the present invention, there is provided a stainless steel wire for cold heading, the stainless steel wire comprising a phosphate coating formed on a surface thereof and a bonde lube coating formed on the phosphate coating. The phosphate coating formed on the surface of the stainless steel wire and the bonde lube coating formed on the phosphate coating may have a weight of 4.0 to 14.0 g/m². The bonde lube coating may comprise a zinc stearate layer formed on the phosphate coating and a sodium stearate layer formed on the zinc stearate layer.

According to another aspect of the present invention, there is provided a self-drilling screw comprising: a screw part including a screw formed on an outer circumference thereof and point formed at the end thereof; and a head part formed on the other end of the screw part opposite to the end of the screw part where the point are formed, wherein the screw point comprises: a stainless steel wire; and a phosphate coating formed on a surface of the stainless steel wire. A bonde lube coating may be formed on the phosphate coating of the screw part. The head part may comprise: a stainless steel; and a phosphate coating formed on a surface of the stainless steel wire. A bonde lube coating may be formed on the phosphate coating of the head part.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial cross-sectional view of a phosphate coated stainless steel wire for cold heading according to an embodiment of the present invention;

FIG. 2 is a side view of a self-drilling screw using a phosphate coated stainless steel wire for cold heading according to an embodiment of the present invention;

FIGS. 3A through 3F illustrate a heading process of forming a screw using a phosphate coated stainless steel wire for cold heading through a heading process according to an embodiment of the present invention;

FIG. 4 illustrates a material flow of the stainless steel wire near a boundary between the stainless steel wire and a tool during the method of FIGS. 3A through 3F;

FIG. 5 is a side view of the screw completed by the heading process of FIGS. 3A through 3F;

FIGS. 6A through 6C illustrate a pointing process of forming a self-drilling screw using the screw with a head part completed by the heading process of FIG. 5, according to an embodiment of the present invention;

FIG. 7 illustrates the screw with the head part and point formed by the pointing process of FIGS. 6A through 6C to which burr is attached;

FIG. 8 illustrates the screw of FIG. 7 from which the burr is removed; and

FIG. 9 illustrates a self-drilling screw screw-processed and barrel-polished after and the pointing process of FIGS. 6A through 6C.

### DETAILED DESCRIPTION OF THE INVENTION

The present invention will now be described more fully with reference to the accompanying drawings, in which exemplary embodiments of the invention are shown.

A phosphate coated stainless steel wire for cold heading according to an embodiment of the present invention will now be explained.

A bright annealed wire is prepared as a stainless steel wire containing by weight less than 0.15% of carbon (C), less than 1.0% of silicon (Si), less than 1.0% of manganese (Mn), 11.50-13.50% of chrome (Cr), less than 0.040% of phosphorus (P), and less than 0.030% of sulfur. The stainless steel wire may have a tensile strength of less than 550 N/mm².

The prepared stainless steel wire is electrolytic pickled using a sulfuric acid solution as an electrolytic solution to completely remove scale on a surface. Next, the stainless steel wire is cathodized in a coating bath, which uses a phosphoric acid solution as an electrolytic solution, to form a phosphate coating. The electrolytic solution includes 0.5-100 g/l of Ca⁺², 0.5-100 g/l of Zn⁺², 5-100 g/l of PO₄⁻³, 0-100 g/l of NO₃⁻¹, 0-100 g/l of ClO⁻³, and 0-59 g/l of F⁻ or C⁻. The temperature, PH, and current density of the electrolytic solution are 0-95° C., 0.5-5.0, and 0.1-250 mA/cm², respectively.

It is impossible or very difficult to form a phosphate coating on a surface of a stainless steel wire since a passiviation coating is generally formed on the surface of the stainless steel wire. Since a zinc or phosphoric acid based coating generally used for a carbon steel wire cannot penetrate into the passivation coating formed on the surface of the stainless steel wire, the zinc or phosphoric acid based coating cannot be formed on the surface of the stainless steel wire on which the passivation coating is formed. Also, even though the passiviation coating formed on the surface of the stainless steel wire may be penetrated into, if the surface of the stainless steel wire is exposed to air, another passivation coating is instantly formed on the surface of the stainless steel wire. Accordingly, it is very difficult to form a zinc or phosphoric acid based coating on the surface of the stainless steel wire on which the passivation coating is penetrated into. However, a phosphate coating can be easily formed on a surface of a stainless steel wire using the above method.

The phosphate coated stainless steel wire can significantly improve cold headability and anti-seizure property when compared with an oxalate coated stainless steel wire. Also, the phosphate coated stainless steel wire has high lubricant pick up, high lubricity, and better appearance than the dark appearance of the oxalate coated stainless steel wire. In addition, the phosphate coated stainless steel wire is environment-friendly because it prevents pollution caused by a post-process after a heading process and also prevents pollution that the oxalate coated stainless steel wire encounters.

The phosphate coating formed on a surface of the stainless steel wire is controlled to have a weight of 4.0 g/m² to 14.0 g/m².

The stainless steel wire on which the phosphate coating having a weight of 4.0 g/m² to 14.0 g/m² is formed can have high corrosion resistance and lubricity, and high crack resistance during a heading process, and can drastically reduce the abrasion of a tool such as a Phillips cross (+) groove forming punch. The stainless steel wire can be used to produce mechanical components formed through a multi-step process or self-drilling screws that go through a severe pointing process to form sharp point.

The phosphate coated stainless steel wire may be rinsed and dried and then may be dipped in a coating bath, which uses a bonde lube solution including sodium stearate and borax as a coating solution, to form a bonde lube coating. The bonde lube solution contains sodium stearate as a main component and a small amount of additive. The temperature of the bonde lube coating bath is 60-80° C., dipping time is 1-2 minutes, density is 3.5-4.5 point, and glass alkalinity is 0-0.5. When the bonde lube coating is formed, the total weight of a coating including the phosphate coating and the bonde lube coating would be controlled to range from 4.0 to 14.0 g/m².

When the phosphate coated stainless steel wire is dipped in the coating bath using the bonde lube solution as the coating solution, the phosphate coating and the sodium stearate of the bonde lube solution react with each other to form a zinc stearate layer, which is a metal soap layer, on the phosphate coating. A sodium stearate layer is formed on the zinc stearate layer.

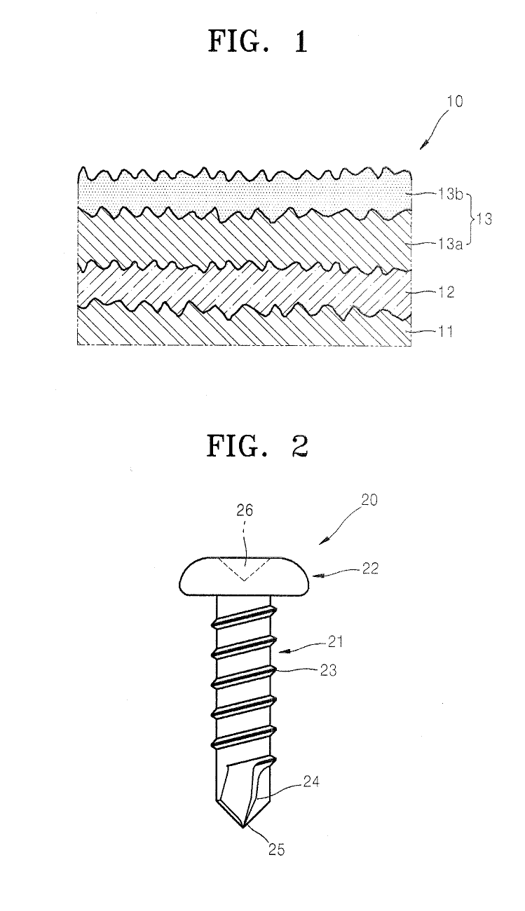

FIG. 1 is a partial cross-sectional view of a stainless steel wire 10 having a surface on which a phosphate coating 12 and a bonde lube coating 13 are formed according to an embodiment of the present invention. Referring to FIG. 1, the stainless steel wire 10 includes the phosphate coating 12 formed on a surface of a stainless steel wire 11, a zinc stearate layer 13a formed on the phosphate coating 12, and a sodium stearate layer 13b formed on the zinc stearate layer 13a. That is, the stainless steel wire 11 of FIG. 1 has the three coating layers thereon, i.e., the phosphate coating 12, the zinc stearate layer 13a, and the sodium stearate layer 13b. Here, the zinc stearate layer 13a and the sodium stearate layer 13b constitute the bonde lube coating 13 that is formed after dipping the stainless steel wire 11 with the phosphate coating 12 in a coating bath that uses a bonde lube solution as a coating solution as described above. The bonde lube coating 13 has a uniform thickness and makes the stainless steel wire 11 sliver-gray colored. Also, the bonde lube coating 13 having lubricity itself improves the headability of the stainless steel wire 11 and enables a lubricant to be easily attached to a surface of the stainless steel wire 11, thereby reducing shear resistance while processing the stainless steel wire 11.

The stainless steel wire 11 having the phosphate coating 12 and the bonde lube coating 13 formed thereon is skin-pass drawn through one or more dies with a reduction of cross-sectional area of 5-15% to complete the stainless steel wire 11 with a predetermined size and strength. A lubricant can be uniformly attached to the surface of the stainless steel wire 11 by providing a powder lubricant to the dies during the wiredrawing process. Since the attached lubricant acts as an auxiliary lubricant when the stainless steel wire is cold headed, friction between a cold heading tool and the stainless steel wire 11 can be reduced, thereby enhancing the life of the cold heading tool.

The completed stainless steel wire can be used to produce mechanical components in specific shapes through a cold heading process, such as small screws, wood screws, tapping screws, or bolts.

FIG. 2 is a side view of a self-drilling screw 20 including a stainless steel wire on which a phosphate coating and a bonde lube coating are formed according to an embodiment of the present invention.

Referring to FIG. 2, the self-drilling screw 20 includes a screw part 21 and a head part 22. The screw part 21 has a cylindrical shape, and has a screw 23 having a spiral thread at an angle. Point 24 having a spiral thread at an angle greater than that of the thread of the screw 23 are formed at the end of the screw part 21. A tip 25 of the point 24 is sharp. The point 24 drill their way into an object to be coupled, and the screw 23 secures the self-drilling screw 20 to the object. The point 24 are formed by a pointing process as will be explained later.

The head part 22 is integrally formed with the other end of the screw part 21 opposite to the first end of the screw part 21, and has a slot (−) or Phillips cross groove (+) 26 formed therein. The head part 22 has a greater diameter than the diameter of the screw part 21, and is formed by a cold heading process as will be explained later.

The head part 22 and the screw part 21 of the self-drilling screw 20 include a stainless steel wire on a surface of which a phosphate coating is formed. The weight of the phosphate coating could be controlled to range from 4.0 to 14.0 g/m². A bonde lube coating could be further formed on the phosphate coating formed on the surface of the stainless steel wire. In this case, the total weight of a coating including the phosphate coating and the bonde lube coating could be controlled to range from 4.0 to 14.0 g/m².

Since the self-drilling screw 20 is made from the stainless steel wire on which the phosphate coating is formed or both the phosphate coating and the bonde lube coating are formed, the surface of the self-drilling screw 20 is silver-gray colored and untainted. Since the phosphate coating has high adhesion to the stainless steel wire, there is no risk of producing fine particles and dusts during a heading process.

Since the phosphate coating is formed to have a weight of 4.0 to 14.0 g/m² or the coating including the phosphate coating and the bonde lube coating is formed to have a weight of 4.0 to 14.0 g/m², the self-drilling screw 20 has high pointing workability to have sharp point, and also features high roll forming property, easy removal of burrs and high lubricity. The self-drilling screw 20 can enhance the life of a tool, such as a die or a punch, when compared with its conventional counterpart. Also, the self-drilling screw 20 had a good torque performance as observed in a torque test and had a much shorter insertion time than its conventional counterpart. For example, the self-drilling screw 20 drilled into a 2.0-13.0 mm steel plate in a much shorter insertion time than a given limited time. Also, the self-drilling screw 20 is environment-friendly because the self-drilling screw 20 does not include an oxalate coating that causes pollution during a heading or pointing process.

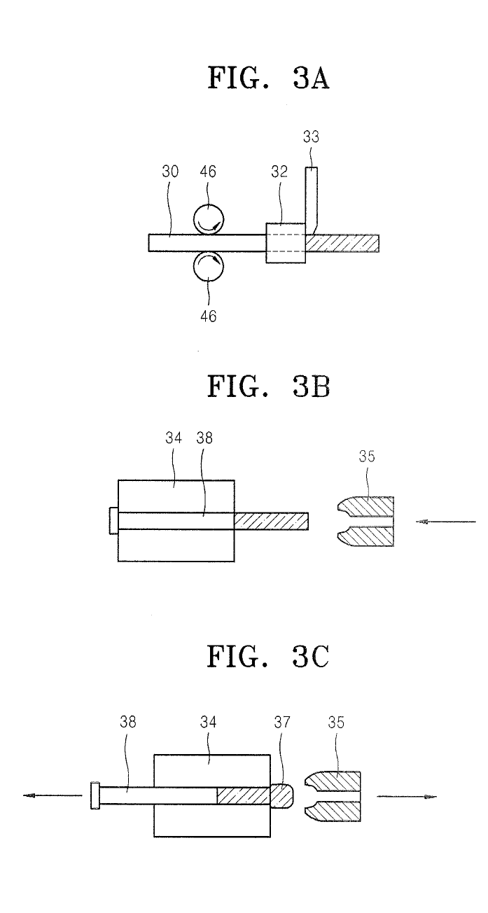

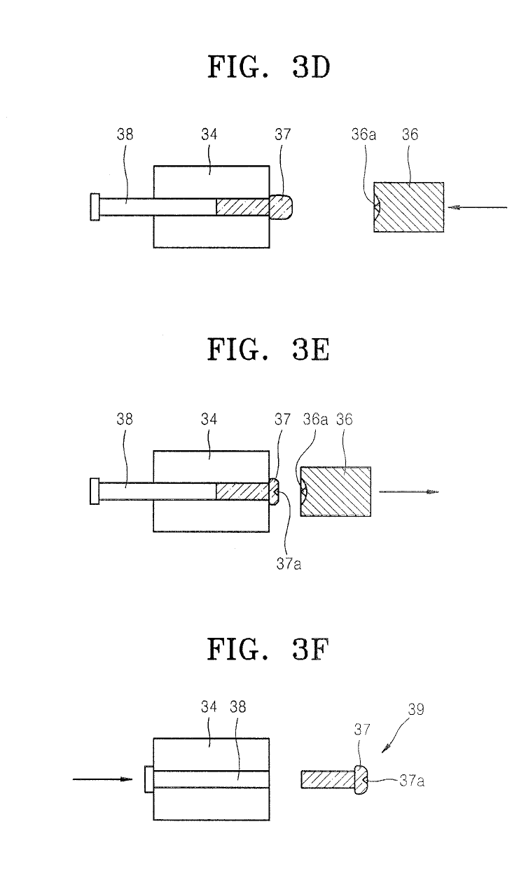

FIG. 3a through 3F illustrate a heading process of forming a screw using a phosphate coated stainless steel wire for cold heading according to an embodiment of the present invention. Referring to FIG. 3A, a stainless steel wire 30 on which a phosphate coating is formed as described above is carried by rollers 46 to a cutting die 32, passed through the cutting die 32, and cut by a cutting knife 33 into a predetermined length. Referring to FIG. 3B, the stainless steel wire 30 cut into the predetermined length is sent to an orifice of a head part forming die 34.

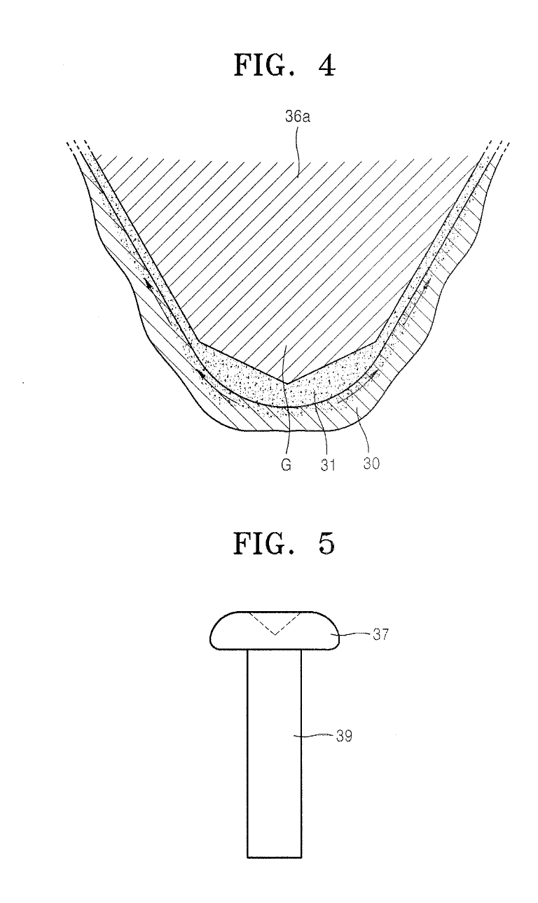

Referring to FIG. 3C, a screw head part 37 is pre-formed by a first tool 35, such as a punch having a groove corresponding to the screw head part 37, Referring to FIGS. 3D and 3F, the screw head part 37 is compressed by a second tool 36, such as a punch having a predetermined projection, such as a Phillips cross (+) projection 36a, to form a Phillips cross (+) groove 37a corresponding to the Phillips cross (+) projection 36a in the head part 37. FIG. 4 illustrates a material flow of the stainless steel wire 30 near a boundary between the stainless steel wire 30 and the Phillips cross (+) projection 36a of the second tool 36. The flow of the material of the stainless steel wire 30 is indicated by arrows in FIG. 4. Also, when the Phillips cross (+) groove 37a is formed in the screw head part 37, severe friction occurs at the boundary between the stainless steel wire 30 and the second tool 36. As a result, an end G of the cross (+) projection 36a of the second tool 36 may be remarkably abraded or damaged. However, since a phosphate coating 31 is formed on a surface of the stainless steel wire 30 including a contact surface between the stainless steel wire 30 and the Phillips cross (+) projection 36a of the second tool 36, abrasion or damage to the Phillips cross (+) projection 36a and the end G of the Phillips cross (+) projection 36a can be prevented. A bonde lube coating (not shown) including a zinc stearate layer or a sodium stearate layer may be further formed on the phosphate coating 31. In this case, abrasion or damage to the Phillips cross (+) projection 36a and the end G of the Phillips cross (+) projection 36a of the second tool 36 can be further noticeably prevented. Referring to FIG. 3F, a screw 39 having the completed head part 37 is expelled from the head part forming die 34 by a knock-out pin 38.

FIG. 5 is a side view of the screw 39 with the completed head part 37 after expelled from the head part forming die 34.

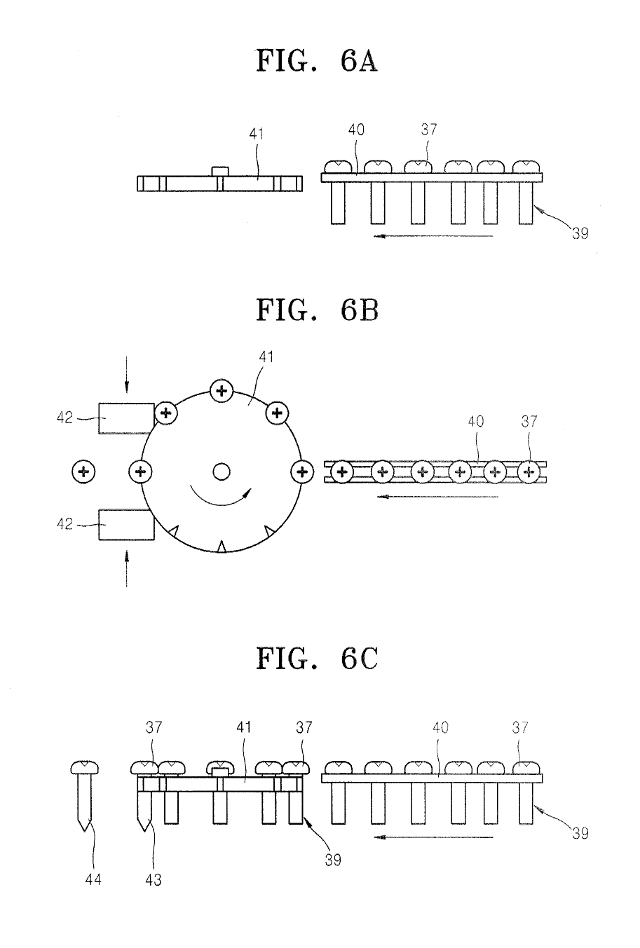

FIGS. 6A through 6C illustrate a pointing process of forming a self-drilling screw using the screw 39 with the completed head part 37 of FIG. 5, according to an embodiment of the present invention.

Referring to FIG. 6A, the screw 39 with the completed head part 37 is transported to a rotating plate 41 by a conveyor rail 40. Referring to FIG. 6B, the screw 39 is transported and fixed at the rotating plate 41 and is moved to a position between a pair of pointing dies 42. Referring to FIG. 6C, the screw 39 moved to the position between the pointing dies 42 and point 43 is formed by the pair of pointing dies 42.

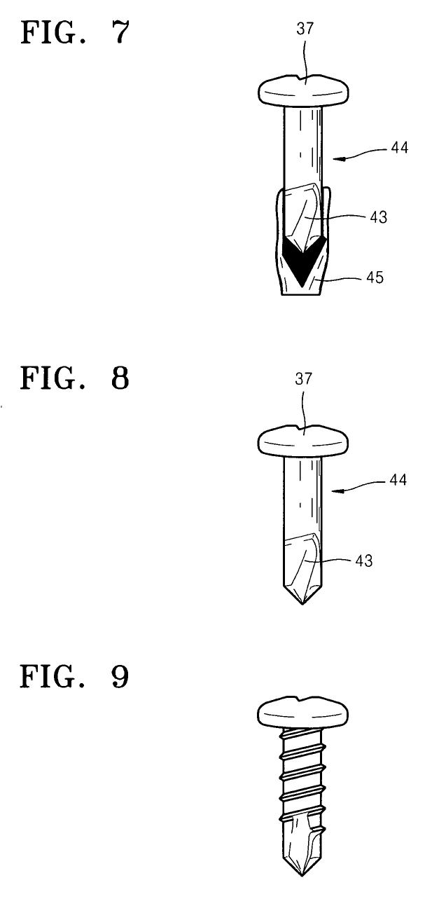

FIG. 7 illustrates a screw 44 having the head part 37 and the point 43 formed by the pointing process of FIGS. 6A through 6C to which a burr 45 is attached. FIG. 8 illustrates the screw 44 having the head part 37 and the point 43 of FIG. 7 from which the burr 45 is removed.

After the burr 45 is removed from the screw 44, the screw 44 is thread-processed and barrel-polished. The bonde lube coating or the phosphate coating formed on the surface of the self-drilling screw is removed through the barrel polishing, and thus the weight of the coating remaining on the surface of the self-drilling screw may not be between 4.0 and 14.0 g/m². FIG. 9 illustrates a self-drilling screw after the pointing process and thread-processed and barrel polished of FIG. 6A through 6C.

### EXAMPLE

Examples according to the present invention will now be explained.

A 3.46 mm diameter bright annealed intermediate wire is prepared as a stainless steel wire containing by weight 0.100% of carbon (C), 0.110% of silicon (Si), 0.390% of manganese (Mn), and 11.690% of chrome (Cr). The stainless steel wire is electrolytic pickled using a sulfuric acid solution as an electrolytic solution to completely remove contamination and scale on a surface. Next, the stainless steel wire is cathodized in a coating bath, which uses a phosphoric acid solution of Table 1 as an electrolytic solution, to form a phosphate coating on the surface of the stainless steel wire. Next, in order to increase lubricity, the phosphate coated stainless steel wire is dipped in a coating bath, which uses a bonde lube solution including sodium stearate and borax as a coating solution, and then dried to form a bonde lube coating on the phosphate coating. Prototypes in Present Examples 1 through 7 and Comparative Examples 1 through 4 were manufactured using the same intermediate wire, the same electrolytic solution, and the same wire speed, different current densities, and different phosphate coating weights and a prototype in Comparative Example 5 was manufactured using an oxalate coating.

TABLE 1

| | | | | | | | Solution | |
|---|---|---|---|---|---|---|---|---|
| Ca⁺² | Zn⁺² | PO₄⁻³ | NO³⁻ | ClO³⁻ | F⁻ | PH | temperature | Bonde lube |
| 17.20 g/l | 3.92 g/l | 84.55 g/l | 35.34 g/l | — | 0.38 g/l | 2 | 25° C. | Sodium stearate etc. |

TABLE 2

| | Item | | | | | | | | | |
|---|---|---|---|---|---|---|---|---|---|---|
| | | | Reduction | | | | | | | |
| | | | of | | | | Life of | | | |
| | Wire | Tensile | cross-sectional | Current | Dipping | Coating | punch | Life of | | Insertion |
| | diameter | strength | area | density | time | weight | (pieces/ | pointing die | Torque | time |
| Example | (mm) | (N/mm²) | (%) | (mA/cm²) | (sec) | (g/m²) | punch) | (pieces/die) | (kgf · cm) | (sec) |
| Present 1 | 3.37 | 554 | 82 | 5 | 26 | 4 | 52,000 | 192,000 | 6.5 | 2.80 |
| Present 2 | 3.37 | 554 | 82 | 7 | 26 | 6 | 54,000 | 195,000 | 6.5 | 2.75 |
| Present 3 | 3.37 | 554 | 82 | 10 | 26 | 8.5 | 55,000 | 210,000 | 6.5 | 2.76 |
| Present 4 | 3.37 | 554 | 82 | 12 | 26 | 10 | 56,000 | 230,000 | 6.5 | 2.75 |
| Present 5 | 3.37 | 554 | 82 | 14 | 26 | 11.6 | 55,000 | 220,000 | 6.5 | 2.76 |
| Present 6 | 3.37 | 554 | 82 | 16 | 26 | 12.9 | 54,000 | 220,000 | 6.5 | 2.75 |
| Present 7 | 3.37 | 554 | 82 | 18 | 26 | 14 | 54,000 | 190,000 | 6.5 | 2.74 |
| Comparative 1 | 3.37 | 554 | 82 | 2 | 26 | 1.5 | 32,000 | 135,000 | 6.5 | 4.96 |
| Comparative 2 | 3.37 | 554 | 82 | 4 | 26 | 3.2 | 43,000 | 143,000 | 6.5 | 3.95 |
| Comparative 3 | 3.37 | 554 | 82 | 20 | 26 | 15.3 | 45,000 | 165,000 | 6.5 | 3.84 |
| Comparative 4 | 3.37 | 554 | 82 | 26 | 26 | 20 | 41,000 | 152,000 | 6.5 | 4.75 |
| Comparative 5 | 3.37 | 550 | 82 | — | — | 6 | 50,000 | 180,000 | 6.5 | 2.76 |

Results in Present Examples 1 through 7 and Comparative Examples 1 through 5 of Table 2 are experimental results obtained by drawing the coated intermediate wire 3.46 mm diameter to a finished wire 3.37 mm diameter and simultaneously performing heading and pointing processes on the finished wire 3.37 mm diameter at a rate of 200 pieces/min.

Referring to Table 2, the life of the heading punch in each of Present Examples 1 through 7 was between 52,000 and 56,000, which was equal to or longer than that of the heading punch in Comparative Example 5 using an oxalate coated wire. However, the life of the punch in each of Comparative Examples 1 through 4 was shorter than that of the punch in Comparative Example 5.

The life of the pointing die in each of Present Examples 1 through 7 was between 185,000 and 230,000 which was longer than that of the pointing die in Comparative Example 5 using the oxalate coated wire. The life of the pointing die in each of Comparative Examples 1 through 4 was shorter than that of the pointing die in Comparative Example 5.

When the total weight of the coating including the phosphate coating and the bonde lube coating was less than 4.0 g/m², the life of the punch or the pointing die was reduced because of low heading and pointing lubricity. When the total weight of the coating including the phosphate coating and the bonde lube coating was greater than 14.0 g/m², the coating was adhered to a mold of the punch or the pointing die, thereby degrading heading or pointing lubricity and reducing the life of the punch or the pointing die. Also, when the total weight of the coating including the phosphate coating and the bonde lube coating was greater than 14.0 g/m² current density has to be increased as the weight of the phosphate coating increased, thereby increasing manufacturing costs. In addition, when the total weight of the coating including the phosphate coating and the bode lube coating was greater than 14.0 g/m², fine particles of the phosphate coating were produced by friction in the feeding roller, thereby causing pollution in work environment. In this regard, it is preferable that the total weight of the coating including the phosphate coating and the bonde lube coating range from 4.0 to 14.0 g/m².

Table 2 also shows results obtained by collecting 30 samples from the respective self-drilling screws, inserting the 30 samples into a steel plate with a weight of 13.5 kgf of thickness 2.30 mm, and measuring their insertion times. It is assumed that if the insertion time of a self-drilling screw exceeds 4.51 seconds, the self-drilling screw is not suitable for a pointing process. Referring to Table 2, the insertion time in each of Present Examples 1 through 7 was between 2.74-2.80 seconds, which was similar to that in Comparative Example 5 using the oxalate coated wire. However, the insertion time in each of Comparative Examples 1 through 4 exceeded 4.51 seconds or was 1 second longer than the insertion time in each of Present Examples 1 through 7. It can be seen that when the total weight of the coating including the phosphate coating and the bode lube coating ranged from 4.0 to 14.0 g/m², the lubricity of the phosphate coating was better, thereby making it possible to form sharp point by the pointing process.

Accordingly, the stainless steel wire for cold heading on which the coating including the phosphate coating and the bonde lube coating was formed to have a total weight of 4.0 to 14.0 g/m² had heading and pointing properties equal or superior to those of the stainless steel wire having the oxalate coating. The self-drilling screw manufactured using the phosphate coated stainless steel wire had torque performance and insertion time equal or superior to those of the self-drilling screw manufactured using the oxalate coated stainless steel wire.

Also, the phosphate coated stainless steel wire was environment-friendly because it generated a small amount of sludge in the coating process and didn't produce harmful fumes at all that the oxalate coating process encountered.

Furthermore, the self-drilling screw manufactured using the stainless steel wire for cold heading on which the coating including the phosphate coating and the bonde lube coating was formed to have a total weight of 4.0-14.0 g/m² hardly produced fine particles during the cold heading process, thereby rarely causing pollution in workplace environment or a self-drilling screw manufacturing device.

The effect of the stainless steel wire on which both the phosphate coating and the bonde lube coating were formed was the same as that of a stainless steel wire on which only a phosphate coating was formed without a bonde lube coating.

The self-drilling screw manufactured using the phosphate coated stainless steel wire was silver-gray colored and untainted, thereby making unnecessary a post-process, such as a barrel polishing, after the heading process. On the contrary, the self-drilling screw manufactured using the oxalate coated stainless steel wire was dark colored, and thus should be subjected to the post-process, such as the barrel polishing, after the heading process.

While Present Examples used the STS 410 stainless steel wire as the phosphate coated stainless steel wire, all kinds of phosphate coated stainless steel wires, for example XM-7,430 can be used as the stainless steel wire for cold heading.

The phosphate coated stainless steel wire for cold heading according to the present invention has high cold headability.

The phosphate coated stainless steel wire for cold heading according to the present invention can stand a severe cold heading process such as a pointing process.

The self-drilling screw using the phosphate coated stainless steel wire for cold heading according to the present invention has high clamping force, short insertion time, and good appearance, and does not cause pollution during a manufacturing process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A stainless steel wire for cold heading, the stainless steel wire comprising a phosphate coating formed on a surface thereof.

2. The stainless steel wire of claim 1, wherein the phosphate coating formed on the surface of the stainless steel wire has a weight of 4.0 to 14.0 g/m².

3. The stainless steel wire of claim 1, further comprising a bonde lube coating formed on the phosphate coating.

4. The stainless steel wire of claim 3, wherein the bonde lube coating comprises a zinc stearate layer formed on the phosphate coating and a sodium stearate layer formed on the zinc stearate layer.

5. The stainless steel wire of claim 3, wherein a total weight of the phosphate coating formed on the surface of the stainless steel wire and the bonde lube coating formed on the phosphate coating ranges from 4.0 to 14.0 g/m2.

6. A self-drilling screw comprising:
a screw part including a screw formed on an outer circumference thereof and point formed at a first end thereof; and
a head part formed on the other end of the screw part opposite to the first end of the screw part where the point are formed,
wherein the screw part comprises:
a stainless steel wire; and
a phosphate coating formed on a surface of the stainless steel wire.

7. The self-drilling screw of claim 6, wherein a bonde lube coating is formed on the phosphate coating of the screw part.

8. The self-drilling screw of claim 6, wherein the head part comprises: a stainless steel wire; and a phosphate coating formed on a surface of the stainless steel wire.

9. The self-drilling screw of claim 8, wherein a bonde lube coating is further formed on the phosphate coating of the head part.
